(19) United States
(12) Patent Application Publication
(10) Pub. No.: US 2016/0199997 A1
(43) Pub. Date: Jul. 14, 2016

(54) CUTTER SPARE BLADE AND CUTTER

(71) Applicant: KANEFUSA KABUSHIKI KAISHA, Aichi (JP)

(72) Inventors: Satoru NISHIO, Niwa-gun (JP); Mikihiro ANDO, Niwa-gun (JP); Yuki WADA, Niwa-gun (JP); Toru MINAMI, Niwa-gun (JP)

(73) Assignee: KANEFUSA KABUSHIKI KAISHA, Niwa-gun, Aichi (JP)

(21) Appl. No.: 14/912,841

(22) PCT Filed: Aug. 28, 2014
(86) PCT No.: PCT/JP2014/004431

§ 371 Date: Feb. 18, 2016

(30) Foreign Application Priority Data
Aug. 30, 2013 (JP) 2013-179787

(51) Int. Cl. B27G 13/08; B23C 5/20

(52) U.S. Cl. CPC B27G 13/08; B23C 5/207; B23C 2200/0444; B23C 2200/0455; B23C 2200/0477; B23C 2200/083; B23C 2200/203; B23C 2200/367; B23C 2222/16; B23C 2222/28; B23C 2226/31; B23C 2228/10

(57) ABSTRACT

A spare blade 25 is a square plate formed of cemented carbide and to be attached to an outer circumferential surface of a cutter 10 for forming a plane. A flat face 28 forming cutting edges is a convex portion 28a slightly bulging in a shape of a lateral surface of a single cone, and a center of the square plate lies on an axis of the convex portion 28a. An entire surface of the spare blade 25 is covered with a diamond coating film having a thickness of 5 to 25 μm.

### TECHNICAL FIELD

The present invention relates to a spare blade of a cutter for rotary cutting to be used in a cutting process using a tenoner or a moulder, or a cutting process before bonding an edging strip by an edge bander, when a furniture component, etc. is produced by using a particle board, a medium density fiberboard (MDF), a solid wood board, etc., and also relates to a cutter using such a spare blade.

### BACKGROUND ART

Conventionally, for example, as shown in FIGS. 15A, 15B, a spare blade to be attached to this kind of cutter for rotary cutting has a square plate shape, and both rake faces 3 and a flank face 4 forming cutting edges 2 are straight faces. Therefore, when a plurality of spare blades 1 are attached to a body of a cutter, height differences in boundaries between the spare blades tend to be great and lines are liable to occur on a cut surface of a workpiece. Especially when a face bevel angle formed by a cutting edge direction of each of the spare blades when attached to the body and an axial direction of the body is great, the height differences are even greater. In contrast, for example, as shown in Patent Document 1, side faces of some spare blade 6, which serve as rake faces 7, are arc-shaped curved faces (see FIGS. 16A, 16B). With this type of spare blades 6, boundaries between the spare blades when the spare blades are attached to a body are smooth and height differences between the spare blades are reduced, so lines are suppressed from occurring on a cut surface of a workpiece. However, when compared to machining to form straight side faces of spare blades, curve machining to form arcs on a number of side faces takes a lot of effort, and therefore this type of spare blades are high priced. Furthermore, when a spare blade has arc-shaped side faces, the spare blade tends to be displaced from a spare blade reference plane by screw fastening when attached to a body. Therefore, attachment of such spare blades requires tedious efforts and height differences between the spare blades tend to be great.

Meanwhile, a cutter employing polycrystalline diamond (hereinafter referred to as PCD) as a material of the aforementioned spare blades to be attached to a cutter for rotary cutting in order to secure durability is known, for example, as described in Patent Document 2. However, when the cutter employs PCD spare blades and the spare blades are reground, it is often difficult to keep outer diameters of cutting edges constant or it takes a lot of effort to make adjustment to keep the external dimensions constant, or tedious diameter correction is necessary on a side of a cutting machine. Besides, because of use of an expensive PCD material, such PCD spare blades are expensive.

### CITATION LIST

### Patent Literature

[PTL 1] Japanese Unexamined Utility Model Application Publication No. S62-113,915

[PTL 2] Japanese Unexamined Patent Application Publication (Translation of PCT Application) No. 2013-517,952

### SUMMARY OF INVENTION

### Technical Problem

The present invention has been made to solve these problems. It is an object of the present invention to provide a spare blade of a cutter for rotary cutting capable of reducing height differences in boundaries between a plurality of spare blades when attached to a body of the cutter by simple processing and also capable of having improved durability while using an inexpensive cutting edge material, and a cutter using such a spare blade.

In order to attain the above object, the present invention has the following features: In a spare blade for cutting formed of a hard cutting edge material, having a shape of a plate-like polygon, and to be attached to an outer circumferential surface of a cutter for forming a plane by rotary cutting, a flank surface forming cutting edges is a convex surface bulging in a shape of a lateral surface of a single cone and a center of the polygon lies on an axis of the convex surface. The shape of the lateral surface of the single cone is not limited to a shape of an entire lateral surface of a single cone. Examples of the hard cutting edge material include cemented carbide, tool steel, cermet, PCD, and cubic boron nitride (CBN).

In the present invention having the above constitution, a flank surface forming cutting edges of a spare blade to be attached to an outer circumferential surface of a cutter is a convex surface slightly bulging in a shape of a lateral surface of a single cone. Therefore, the respective cutting edges of the polygon have curves and height differences in boundaries between such spare blades when the spare blades are attached to a body of the cutter can be reduced. As a result, lines are suppressed from occurring on a cut surface of a workpiece in the present invention. Moreover, machining to form such a flank surface of the spare blade, i.e., formation of a conical convex surface can be easily done by a single grinding operation in a shape of a cone along an outer peripheral portion with a center of the polygon on an axis of the cone. As a result, grinding in the present invention can be carried out by a simple operation in a short time when compared to conventional grinding of side surfaces to form curves, so spare blades can be provided at a low cost. Furthermore, since the spare blade of the present invention can have flat side surfaces, the spare blade is not displaced from a spare blade reference plane by screw fastening when attached to a body. Therefore, attachment of the spare blade is easy and does not produce harmful height differences between spare blades.

In addition, in the present invention, preferably the cutting edge material is cemented carbide or cermet, and an entire surface of the cutter spare blade is covered with a hard coating film having a thickness of 1 to 25 μm. More preferably, the hard coating film is formed of chromium nitride, chromium oxide, chromium oxynitride, diamond, diamond-like carbon (DLC) or the like. Furthermore, preferably, diamond is CVD diamond formed by chemical vapor deposition (CVD). Owing to the hard coating film, even a spare blade formed of cemented carbide or cermet can attain improved durability.

Moreover, the present invention can be a cutter having the cutter spare blade recited in any one of claims 1 to 3 attached thereto and forming a face bevel angle of 20 deg. or more. In a case of a cutter using a plurality of spare blades of the present invention, upon thus increasing face bevel angles of the spare blades to 20 deg. or more, height differences in boundaries between the spare blades can be reduced and accordingly differences in an outer diameter of the cutter can be reduced when compared to in a case of a conventional cutter. As a result, in a case of cutting with great face bevel angles in the present invention, lines can be suppressed from occurring on a cut surface of a workpiece.

In the present invention, a flank surface of a spare blade is a convex surface slightly bulging in a shape of a lateral surface of a single cone. Therefore, height differences in boundaries between spare blades when the spare blades are attached to a body of a cutter can be reliably reduced at a low cost. Moreover, in the present invention, cutting edges formed of an inexpensive material such as cemented carbide or cermet are coated with diamond. Therefore, durability of spare blades can be improved at a low cost.

### BRIEF DESCRIPTION OF DRAWINGS

FIG. 1 is a perspective view schematically showing a cutter for rotary cutting according to an example of the present invention.

FIG. 2 is a front view schematically showing the cutter shown in FIG. 1.

FIG. 3 is a right side view schematically showing the cutter.

FIG. 4 is a front view of a spare blade to be attached to the cutter.

FIG. 5 is a right side view schematically showing the spare blade shown in FIG. 4.

FIG. 6 is an explanatory diagram for showing how to measure a rake angle of the spare blade.

FIG. 7A is a front view of a triangular spare blade.

FIG. 7B is a right side view of the spare blade shown in FIG. 7A.

FIG. 8A is a front view of a pentagonal spare blade.

FIG. 8B is a right side view of the spare blade shown in FIG. 8A.

FIG. 9 is a perspective view schematically showing a cutter according to a modified example.

FIG. 10 is a front view schematically showing the cutter.

FIG. 11 is a left side view schematically showing the cutter.

FIG. 12 is a graph showing a test result of Specific Example 1.

FIG. 13 is a graph showing a test result of Specific Example 2.

FIG. 14 is a graph showing a test result of Specific Example 3.

FIG. 15A is a front view showing a spare blade to be attached to a cutter according to Conventional Example 1.

FIG. 15B is a right side view showing the spare blade shown in FIG. 15A.

FIG. 16A is a front view showing a spare blade to be attached to a cutter according to Conventional Example 2.

FIG. 16B is a right side view showing the spare blade shown in FIG. 16A.

### DESCRIPTION OF EMBODIMENTS

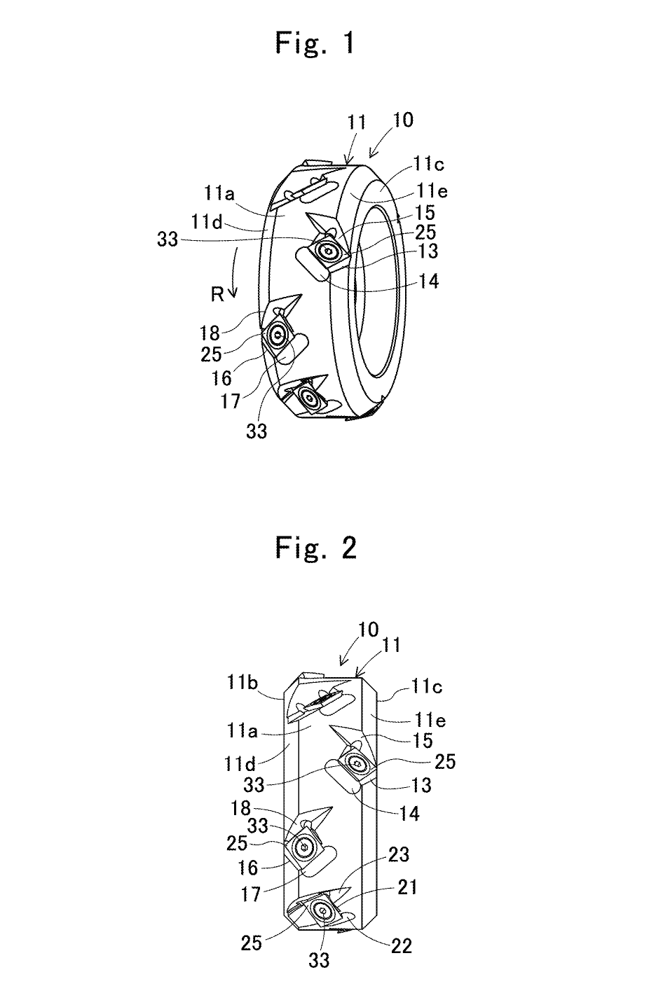

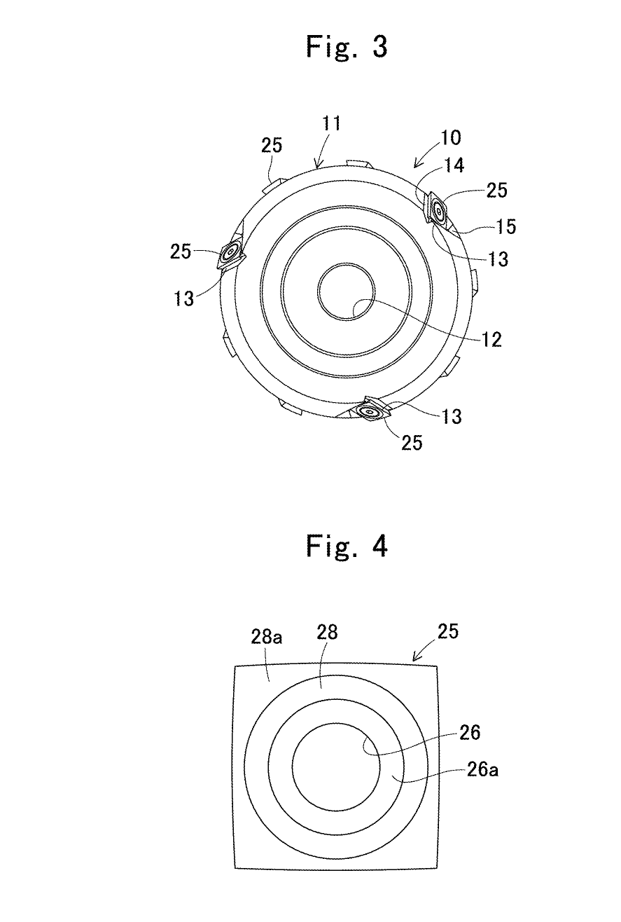

Hereinafter, an example of the present invention will be described with reference to the drawings. FIGS. 1, 2 and 3 are perspective, front, and right side views of a cutter 10 for rotary cutting (hereinafter referred to as a cutter) according to the example. A body 11 constituting the cutter 10 is formed by machining a thick disk-shaped plate formed of steel or aluminum. At its center, the body 11 has a center hole 12 in which a rotary shaft of a processing machine is to be inserted. The body 11 has bevel portions 11d, 11e, which are coaxially cut out at an angle of 45 deg. along boundaries between an outer circumferential surface 11a and left or right side surfaces 11b, 11c.

On a right end side of the body 11, mounting seats 13 are provided at three positions at equal circumferential intervals so as to extend over the outer circumference surface 11a and the bevel portion 11e. The mounting seats 13 sink at an inclination angle of about 10 deg. in an opposite direction to a rotation direction R and are inclined in an inward direction at an angle of 45 deg. with respect to an axial direction. Provided ahead in a rotation direction of the mounting seats 13 are chip pockets 14 which dent from the mounting seats 13. Provided behind in the rotation direction of the mounting seats 13 are positioning portions 15 which slightly protrude from the mounting seats 13. On a left end side of the body 11, mounting seats 16 are provided at three positions spaced circumferentially from the aforementioned mounting seats 13 by an angle of 40 deg. so as to extend over the outer circumferential surface 11a and the bevel portion 11d. The mounting seats 16 sink at an inclination angle of about 10 deg. in an opposite direction to the rotation direction R and are inclined in an inward direction at an angle of 45 deg. with respect to the axial direction. That is to say, the inclination of the mounting seats 16 is opposite to that of the mounting seats 13. Provided ahead in the rotation direction of the mounting seats 16 are radially dented chip pockets 17. Provided behind in the rotation direction of the mounting seats 16 are positioning portions 18 which slightly protrude from the mounting seats 16.

On an outer circumferential surface 11a of the body 11, mounting seats 21 are provided at three positions spaced ahead in the rotation direction from the above mounting seats 16 by an angle of 40 deg. The mounting seats 21 are inclined in parallel to the above mounting seats 16. Provided ahead in the rotation direction of the mounting seats 21 are radially dented chip pockets 22. Provided behind in the rotation direction of the mounting seats 21 are positioning portions 23 which slightly protrude from the mounting seats 21. Each of the mounting seats 13, 16 and 21 has a threaded mounting hole, not shown, at its center for fixing a spare blade 25 to be mentioned later.

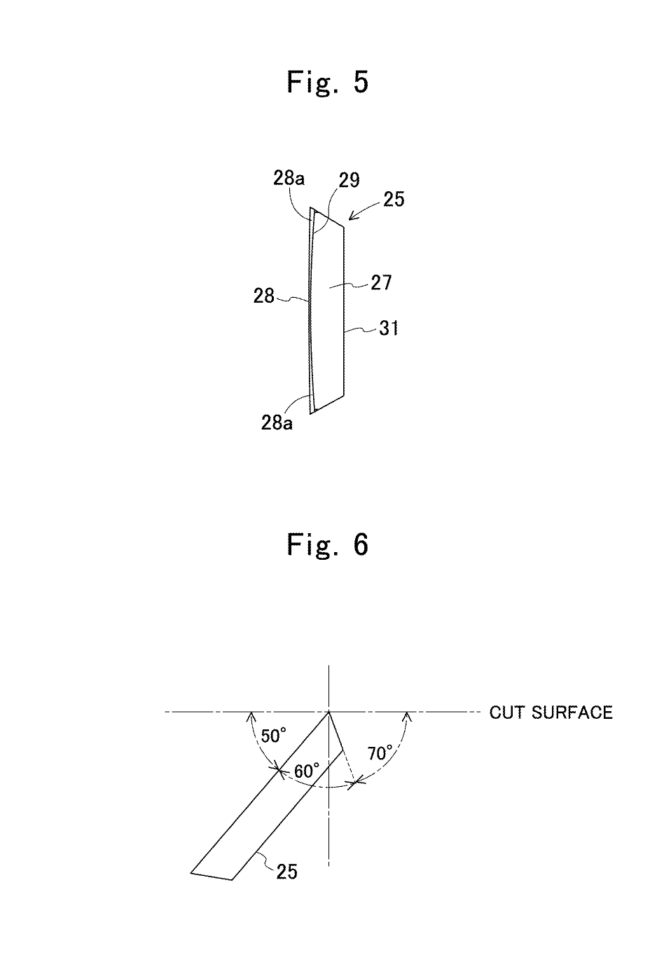

As shown in FIGS. 4 and 5, each spare blade 25 is a thin square plate formed by machining cemented carbide or cermet and has a mounting hole 26 at a center thereof, penetrating the plate in correspondence to the aforementioned center hole 12. A flat face 28 side surrounding the mounting hole 26 mentioned later is a depression 26a for receiving a head of a screw 33 for fixing the spare blade 25. In the spare blade 25, four side faces serving as rake faces 27 are inclined at an angle of 45 deg. A larger flat surface called a flat face 28 has an annular convex portion 28a at an outer periphery, slightly bulging in a shape of a lateral surface of a single cone with a center of the square on an axis of the cone. An inclination angle of the convex portion 28a with respect to the flat face is determined within several degrees based on a face bevel angle formed by an axial direction and a direction of an end of a cutting edge when the spare blade 25 is attached to the body 11. Formation of the convex portion 28a can be easily done by conically grinding the flat face 28 once. Thus, ends formed by the four rake faces 27 and the convex portion 28a of the spare blade 25 serve as cutting edges 29, respectively. A flat face on an opposite side serves as a mounting face 31 to come in close contact with one of the mounting seats 13, 16, 21. A diamond coating film, not shown, is formed in a range of from 5 to 25 μm on an entire surface of the spare blade 25 by CVD.

Since the convex portion 28a is formed on the flat face 28 as mentioned above, in the spare blade shown in FIGS. 4 and 5, edge lines of the cutting edges 29 draw an arc shape from a center to both sides and four corners are inclined in a thickness direction from the center. The spare blade 25 is located by overlaying the mounting face 31 on one of the mounting seats 13, 16, 21 and bringing one rake face 27 serving as a locator in contact with the one of the positioning portions 15, 18, 23, and fixed by fastening a screw 33 through the mounting hole 26 into a mounting hole of the one of the mounting seats 13, 16, 21. In attaching the spare blade 25, at least two of the four rake faces 27 of the spare blade 25 are used as mounting reference surfaces or mounting constraint surfaces in order to prevent dislocation. When the spare blade 25 is thus attached, very ends of the cutting edges 29 of the spare blade 25 slightly protrude from the outer circumferential surface of the body 11. Moreover, the sign of a face bevel angle of the spare blades 25 attached to the mounting seats 13 is opposite to that of a face bevel angle of the spare blades 25 attached to the mounting seats 16 and 21.

In the example having the aforementioned constitution, the flank face forming the cutting edges 29 of the spare blade 25 attached to the outer circumferential surface of the cutter 10 is the convex portion 28a slightly bulging in a shape of a lateral surface of a single cone. Therefore, in the spare blade shown in FIGS. 4 and 5, edge lines of the cutting edges 29 draws an arc shape from a center to both sides and four corners are inclined in a thickness direction from the center. Therefore, when a plurality of such spare blades 25 are attached to the body 11 of the cutter 10, height differences in boundaries between the spare blades 25 can be reduced. As a result, in the present example, lines are suppressed from occurring on a cut surface of a workpiece and a smooth cut surface can be obtained. Height differences can be reduced by appropriately adjusting the inclination angle of the convex portion 28a based on the magnitude of the face bevel angle formed by the cutting edge direction when the spare blade 25 is attached to the body 11 and the axial direction of the body 11.

Moreover, formation of the convex portion 28a in a cone shape can be easily done by conically grinding an outer periphery once with a center of the square of the spare blade 25 on an axis of the cone. Therefore, machining of the flat face 28 of the spare blade 25 is much easier than conventional machining of the side faces in a curve shape and the spare blade 25 can be provided at a low price. Furthermore, since at least two of the four sides of the spare blade 25 can be used in the present example, use efficiency of the spare blade 25 can be increased. Moreover, since a diamond coating film is formed within a thickness range of 5 to 25 μm on an entire surface of the spare blade 25 in the present example, even a spare blade formed of inexpensive cemented carbide or cermet instead of expensive PCD can attain improved durability. Furthermore, since the side faces serving as the rake faces 27 can be flat, the spare blade 25 of the present example is not dislocated from a reference surface for the spare blade 25 by fastening a screw 33 when the spare blade 25 is attached to the body 11. Therefore, the attachment operation is easy and useless height differences between blades 25 can be prevented from being generated by dislocation in attaching the spare blades 25.

Moreover, in the cutter 10 according to the present example, height differences in boundaries between the spare blades 25 can be reduced even when the face bevel angle of the spare blades 25 is increased to 20 deg. or more. Therefore, even in a case of cutting at a great face bevel angle, lines are suppressed from occurring on a cut surface of a workpiece. Furthermore, the inclination angle of the conical grinding of the spare blade 25 is changed in accordance with a face bevel angle when the spare blade 25 is attached to the body 11, and an outer diameter. The face bevel angle is also changed by whether a laminated material is melamine, paper or the like.

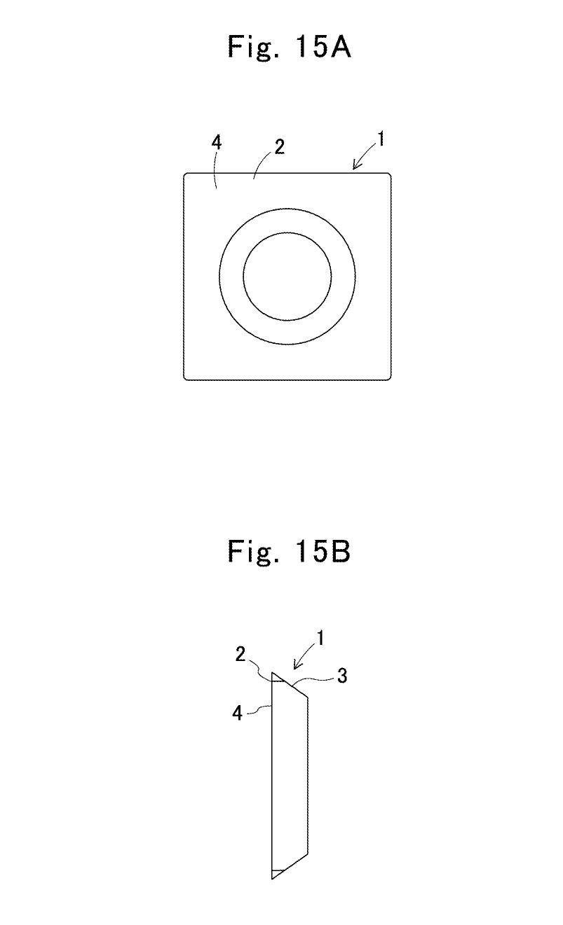

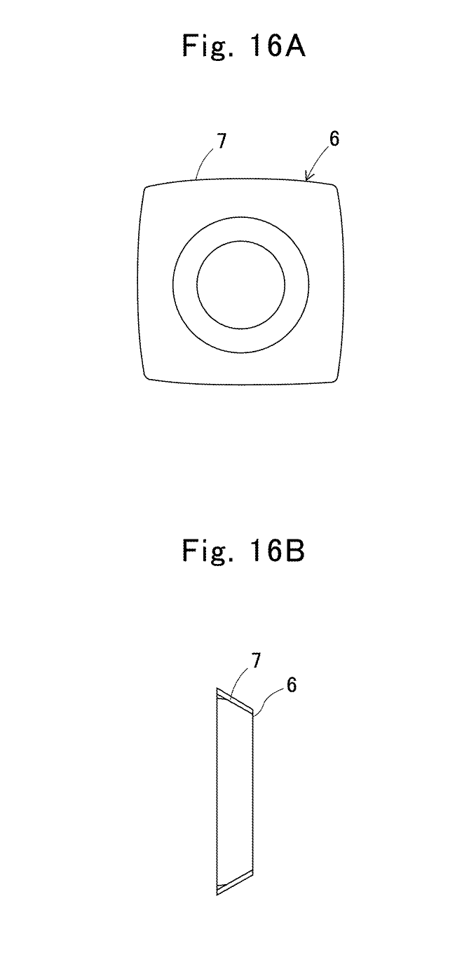

Now, measurement results on a maximum height difference between spare blades when the spare blades are attached at different face bevel angles will be described. Five kinds of spare blades were chosen: one formed by conical grinding (a spare blade according to an example of the present invention), one having straight faces (a conventional spare blade shown in FIGS. 15A and 15B), ones having curved sides with R150, R100, and R50 (conventional spare blades shown in FIGS. 16A and 16B and having different radii of curvature of R mm). Outer dimensions were set to 15 mm×15 mm×2.5 mm and a wedge angle was set to 60 deg.

As shown in FIG. 6, height measurements were done by designing a cutter with a diameter of 125 mm on a three-dimensional CAD program (SolidWorks), and placing spare blades so that a normal rake angle is −20 deg. in a plane normal to the cutting edge. Such spare blade shapes and conical grinding angles to minimize a height difference between spare blades are calculated and maximum height differences of such spare blades when the spare blades were attached at face bevel angles of 20 deg., 30 deg., 45 deg., and 70 deg. were respectively measured. Measurement results are shown in Table 1.

TABLE 1

| FACE BEVEL | | MAXIMUM HEIGHT |
|---|---|---|
| ANGLE | SPARE BLADE SHAPE | DIFFERENCE [mm] |
| 20 deg. | conical grinding | 0.004 |
| | conical grinding angle 0.71 deg. | |
| | straight | 0.092 |
| 30 deg. | conical grinding | 0.009 |
| | conical grinding angle 1.53 deg. | |
| | R150 | 0.005 |
| | straight | 0.196 |
| 45 deg. | conical grinding | 0.017 |
| | conical grinding angle 3.10 deg. | |
| | R100 | 0.101 |
| | straight | 0.393 |
| 70 deg. | conical grinding | 0.028 |
| | conical grinding angle 5.57 deg. | |
| | R50 | 0.086 |
| | straight | 0.691 |

As apparent from Table 1, maximum height differences of the spare blades of the present invention with most appropriate conical grinding angles were much smaller than those of the spare blades with straight faces. The maximum height difference of the spare blades of the present invention with most appropriate conical grinding angles were about as small as that of the spare blade with R150 at a face bevel angle of 30 deg., but much smaller than a maximum height difference of the spare blade with R100 at a face bevel angle of 45 deg. and that of the spare blade with R50 at a face bevel angle of 70 deg. A most appropriate grinding angle of the spare blade is greater with an increase in the face bevel angle.

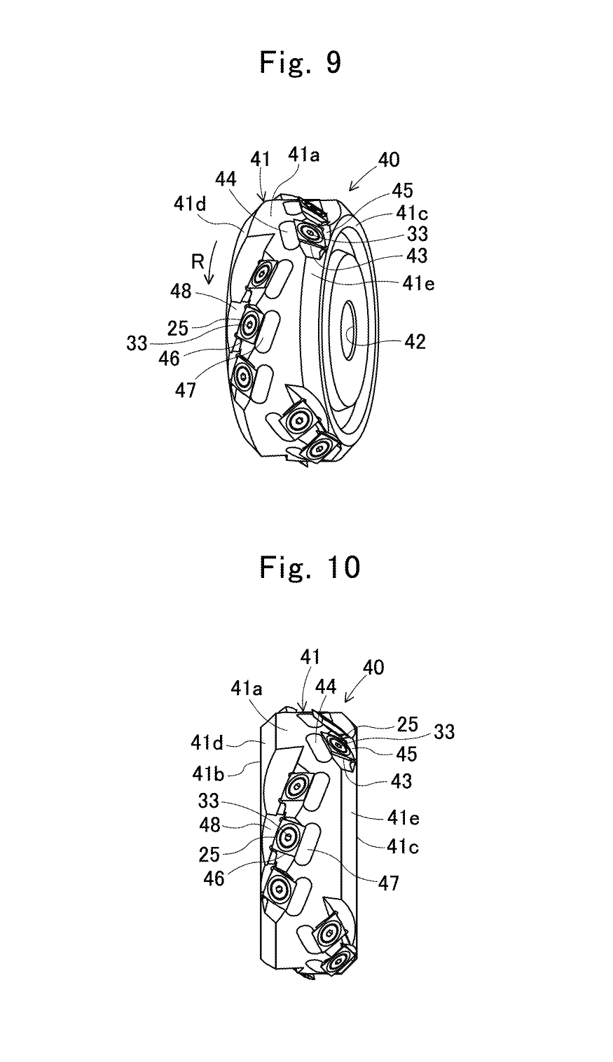

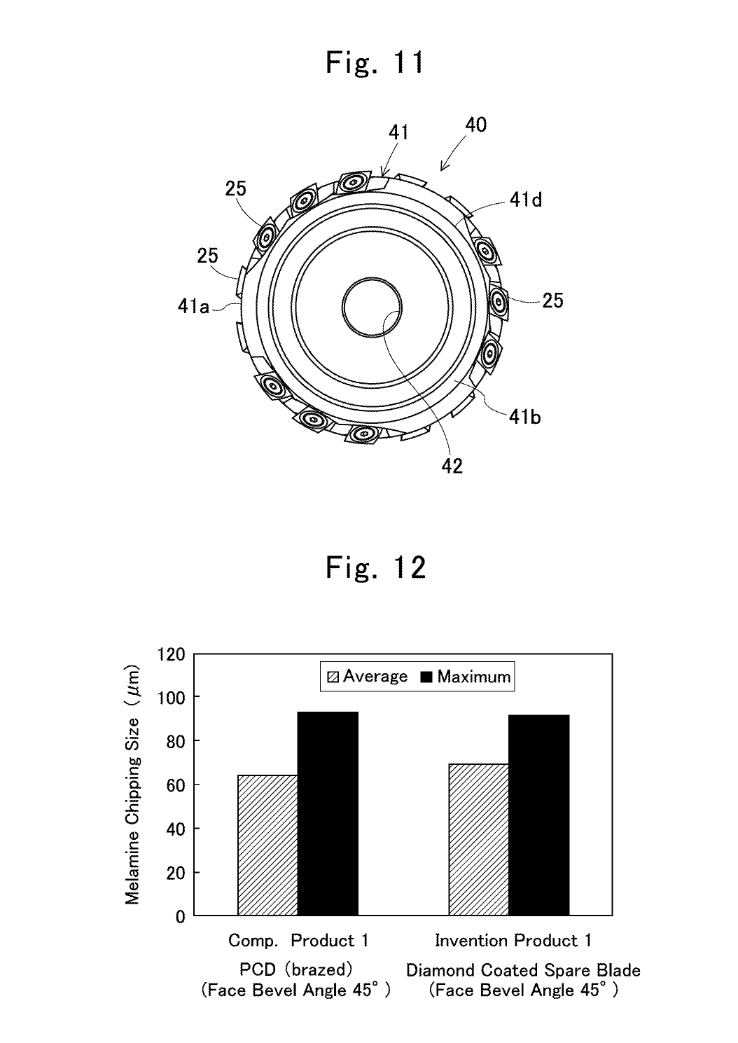

Next, modified examples of the aforementioned example will be described. FIGS. 9, 10 and 11 are perspective, front and left side views of a cutter 40 according to a modified example. A body 41 constituting the cutter 40 has a similar constitution to that of the aforementioned body 11. At its center, the body 41 has a central hole 42 in which a rotary shaft of a processing machine is to be inserted. The body 41 has bevel portions 41d, 41e, which are coaxially cut out at an angle of 45 deg. along boundaries between an outer circumferential surface 41a and left or right side surfaces 41b, 41c.

On a right end side of the body 41, two mounting seats 43 and chip pockets 44 and positioning portions 45 ahead of and behind the two mounting seats 43 are provided within ranges of about 48 deg. at three positions at equal circumferential intervals so as to extend from the bevel portion 41e to a middle of an outer circumference surface 41a. The two mounting seats 43 are sequentially arranged in such a manner that cutting edges are inclined at an angle of 70 deg. with respect to an axial direction. On a left end side of the body 41, three mounting seats 46 and chip pockets 47 and positioning portions 48 ahead of and behind the three mounting seats 46 are provided within ranges of about 72 deg. at three positions spaced circumferentially from the aforementioned mounting seats 43 by an angle of about 72 deg. so as to extend from the bevel portion 41d to a middle of the outer circumference surface 41a. The three mounting seats 46 are sequentially arranged in such a manner that cutting edges are inclined at an angle of 70 deg. with respect to the axial direction. Spare blades 25 are fixed on the mounting seats 43, 46 by screws 33 as mentioned above. A face bevel angle of the spare blades 25 attached to the mounting seats 43 and a face bevel angle of the spare blades 25 attached to the mounting seats 46 are 70 deg, and have an opposite sign to each other.

As a result, although the spare blades 25 in the aforementioned example had a face bevel angle of 45 deg. with respect to the axis, the spare blades 25 in the modified example had a face bevel angle of 70 deg. to the axis. Moreover, the inclination angle of the convex portion 28a of the spare blades 25 with respect to the flat face in the modified example is greater than the inclination angle of the convex portion of the spare blades with respect to the flat face in the aforementioned example. Even when this cutter 40 is employed to cut a workpiece which requires cutting using spare blades fixed at a great face bevel angle and a great face bevel angle is set, lines can be suppressed from occurring on a cut surface of the workpiece.

Next, Specific Examples 1, and 3 for testing cutting performance of cutters produced according to the aforementioned example of the present invention will be sequentially described.

### Specific Example 1

A cutting test was performed on a cutter employing spare blades 25 of a specific example of the present invention as Invention Product 1 and a cutter having brazed PCD blades as Comparative Product 1 under cutting conditions 1 shown below.

### [Invention Product 1]

Spare blade material: cemented carbide, diamond coating (film thickness: 20 μm)

Spare blade dimensions: 15 mm×15 mm×2.5 mm

Spare blade cone inclination angle: 3.66 deg.

Cutter dimensions: outer diameter φ: 125 mm, cutting width: 44 mm, substantial number of blades: 3 pieces

Face bevel angle: 45 deg.

Wedge angle: 60 deg.

### [Comparative Product 1]

Cutting edge material: PCD (brazed)

Cutter dimensions: the same as Invention Product 1

Face bevel angle: 45 deg.

Wedge angle: 60 deg.

### [Cutting Conditions 1]

Workpiece: melamine laminated particle board (thickness: 15 mm)

Number of cutter rotations: 6000 rpm

Feed rate: 20 m/min

Depth of cut: 0.8 mm

When melamine laminated particle boards were cut by Inventive Product 1 and Comparative Product 1, melamine facing chipping size was measured by a roughness meter and measurement results are shown in a graph in FIG. 12. Chipping size of a melamine facing cut by the cutter of Invention Product 1 was about the same as that of a melamine facing cut by the cutter of Comparative Product 1 and initial cutting quality of Invention Product 1 was equal to or greater than that of Comparative Product 1.

### Specific Example 2

A cutting test was performed on a cutter employing spare blades of a specific example of the present invention as Invention Product 2 and cutters having brazed PCD spare blades as Comparative Examples 2, 3 under cutting conditions shown below.

### [Invention Product 2]

Spare blade material: cemented carbide, diamond coating (film thickness: 12 μm)

Spare blade dimensions: 15 mm×15 mm×2.5 mm

Spare blade cone inclination angle: 5.80 deg.

Cutter dimensions: outer diameter φ: 125 mm, cutting width: 44 mm, substantial number of blades: 3 pieces

Face bevel angle: 70 deg.

Wedge angle: 49 deg.

### [Comparative Product 2]

Cutting edge material: PCD (brazed)

Cutter dimensions: the same as Invention Product 2

Face bevel angle: 45 deg.

Wedge angle: 60 deg.

### [Comparative Product 3]

Cutting edge material: PCD (brazed)

Cutter dimensions: the same as Invention Product 2

Face bevel angle: 70 deg.

Wedge angle: 49 deg.

### [Cutting Conditions 2]

Workpiece: Paper laminated particle board (thickness: 15 mm)

Number of cutter rotations: 6000 rpm

Feed rate: 20 m/min

Depth of cut: 0.8 mm

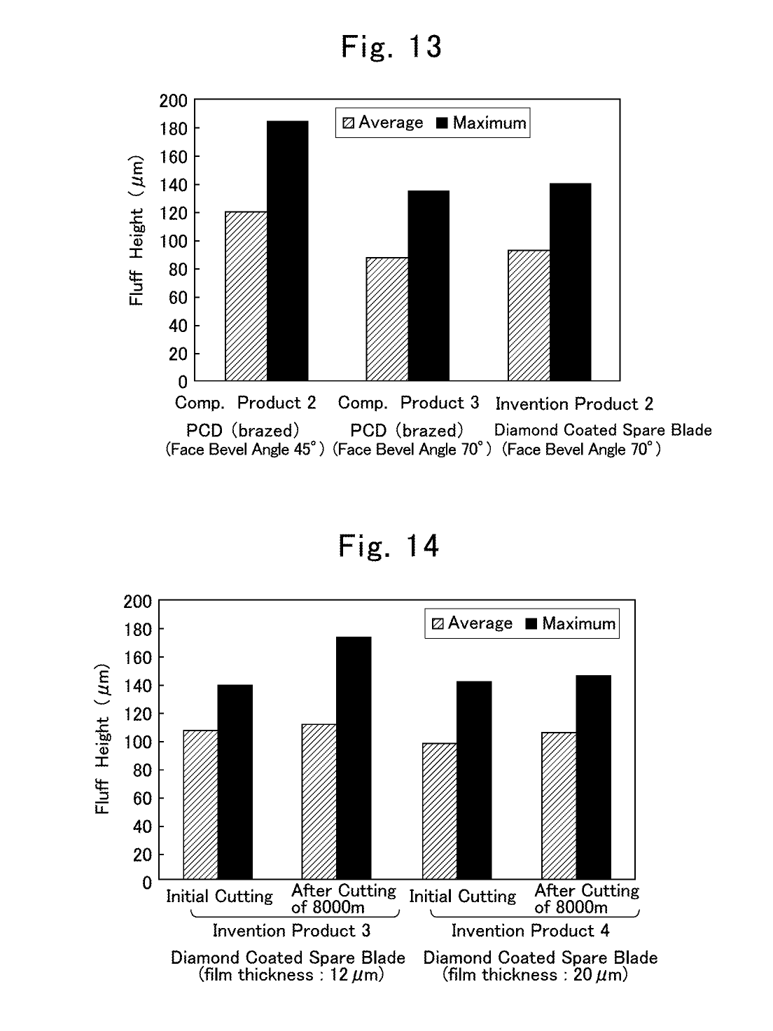

Fluff size was measured with a microscope when a paper laminated particle board was cut by Invention Product 2 and Comparative Products 2, 3 and measurement results are shown in a graph in FIG. 13. Fluff height of the cutter of Invention Product 2 is smaller than that of the cutter of Comparative Product 2 and equal to or slightly greater than that of the cutter of Comparative Product 3. Initial cutting quality of Invention Product 2 is almost the same as those of the comparative products.

### Specific Example 3

A durability test was performed on cutters 3, 4 employing spare blades of a specific example of the present invention as Invention Products 3, 4 under cutting conditions shown below.

### [Invention Products 3, 4]

Spare blade material: cemented carbide, diamond coating (film thickness: 12 μm, 20 μm]

Spare blade dimensions: 15 mm×15 mm×2.5 mm

Spare blade cone inclination angle: 5.80 deg.

Cutter dimensions: outer diameter φ: 125 mm, cutting width: 44 mm, substantial number of blades: 3 pieces

Face bevel angle: 70 deg.

Wedge angle: 49 deg.

### [Cutting Conditions 3]

Workpiece: paper laminated particle board (thickness: 15 mm)

Number of cutter rotations: 6000 rpm

Feed rate: 10 m/min

Depth of cut: 0.5 mm

Total cutting length: 8,000 m

Cutting edges of Invention Products 3, 4 were observed through an electron microscope after cutting paper laminated particle boards for a total cutting length of 8,000 m. Almost no wear was observed on the diamond coatings of the cutting edges and it was found that the spare blades had high wear resistance. Roughness measurement of edge lines of the spare blades revealed that chippings were observed in half of the cutting edges of Invention Product 3 having a thin coating film but no chippings were observed in the cutting edges of Invention Product 4 having a thick coating film.

Fluff height measured with a microscope in initial cutting and after cutting 8,000 m of the boards by Invention Products 3, 4 is shown in a graph in FIG. 14. In a case of Invention Product 3 having a thin coating film, a maximum fluff height was increased but an average fluff height hardly changed after cutting of 8,000 m. In a case of Invention Product 4 having a thick coating film, fluff height hardly changed after cutting of 8000 m. As a result, the spare blades with diamond coating had high durability and their cutting quality hardly changed after cutting of 8,000 m, though size of film thickness made some difference in chippings in the cutting edges.

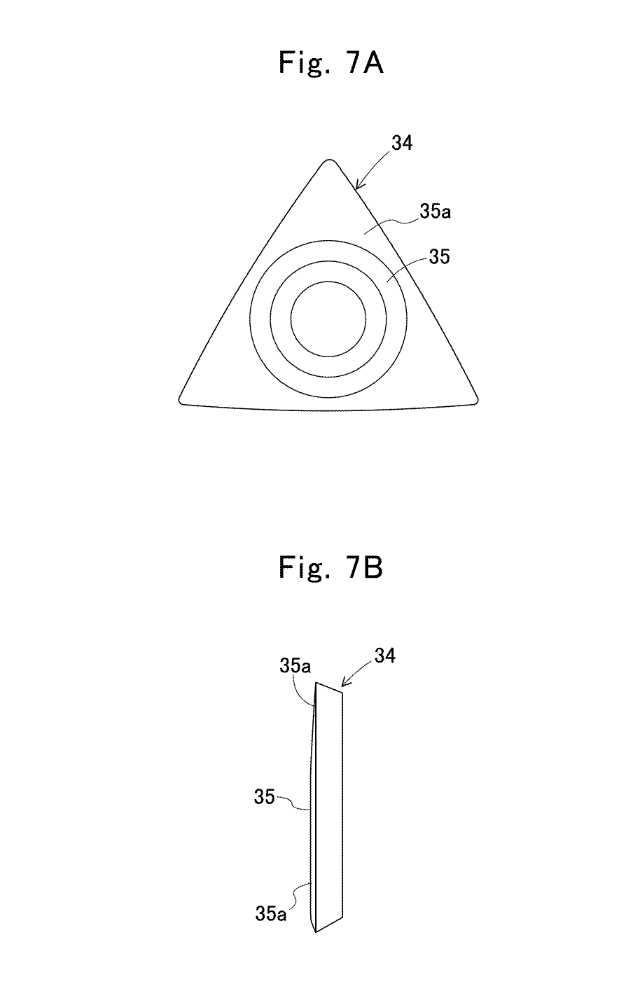

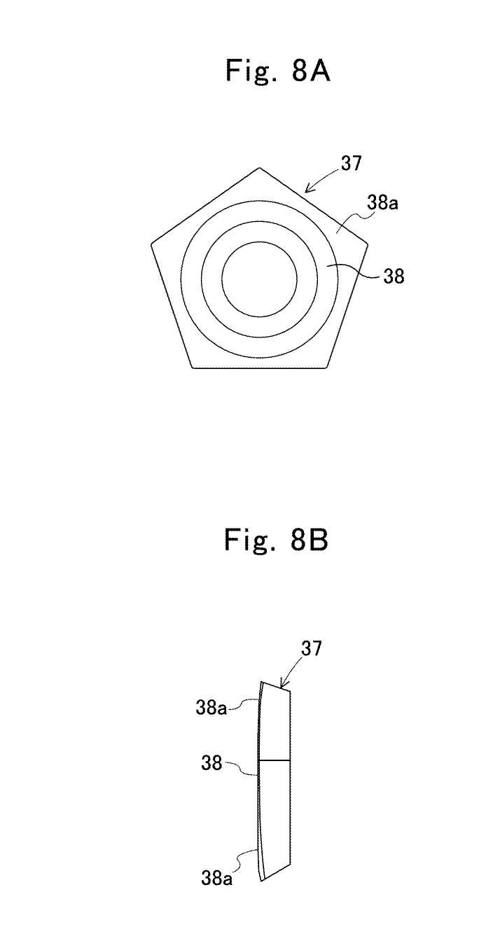

The spare blades 25 in the aforementioned examples are thin square plates. Instead of the spare blades 25, as shown in FIGS. 7A and 7B, a spare blade 34 can be an equilateral triangle having a flat face 35 whose outer peripheral portion is a convex portion 35a in a shape of a lateral surface of a single cone. Moreover, as shown in FIGS. 8A, 8B, a spare blade 37 can be an equilateral pentagon having a flat face 38 whose outer peripheral portion is a convex portion 38a in a shape of a lateral surface of a single cone. Besides, spare blade shape can be a rectangle, an equilateral hexagon or the like although not shown. Such modification in spare blade shape can offer similar advantageous effects to those shown in the aforementioned examples. There is no need to limit normal rake angle to −20 deg. or limit wedge angle to 60 deg. For example, the normal rake angle can be 20 deg. and the wedge angle can be 45 deg. Although cone inclination angle can be constant, a maximum height difference can be reduced by changing cone grinding (inclination) angle.

It should be noted that although diamond coating film is formed on the entire surface of the spare blade formed of cemented carbide or cermet in the aforementioned example, chromium nitride, chromium oxynitride, chromium oxide, DLC or the like can be coated instead of diamond. Moreover, the aforementioned examples are just examples and various modifications are possible without departing from the spirit of the present invention.

### REFERENCE SIGNS LIST

10 Cutter, 11 Body, 13, 16, 21 Mounting seat, 25 Spare blade, 27 Rake face, 28 Flat face, 28a Convex portion, 40 Cutter, 41 Body, 43, 46 Mounting seat

1: A cutter spare blade, comprising a spare blade for cutting formed of a hard cutting edge material, having a shape of a plate-like polygon, and to be attached to an outer circumferential surface of a cutter for forming a plane by rotary cutting, wherein a flank surface forming cutting edges is a convex surface bulging in a shape of a lateral surface of a single cone and a center of the polygon lies on an axis of the convex surface.

2: The cutter spare blade according to claim 1, wherein the cutting edge material is cemented carbide or cermet, and an entire surface of the cutter spare blade is covered with a hard coating film having a thickness of 1 to 25 μm.

3: The cutter spare blade according to claim 2, wherein the hard coating film is formed of CVD diamond.

4: A cutter having the cutter spare blade recited in claim 1 attached thereto and forming a face bevel angle of not less than 20 degrees.
